(19) United States
(12) Patent Application Publication
(10) Pub. No.: US 2011/0290599 A1
(43) Pub. Date: Dec. 1, 2011

(54) Brake Lining Assembly

(75) Inventor: Thomas Vasel, Filsen (DE)

(73) Assignee: LUCAS AUTOMOTIVE GMBH, Koblenz (DE)

(21) Appl. No.: 13/146,071

(22) PCT Filed: Jan. 12, 2010
(86) PCT No.: PCT/EP10/00110

§ 371 Date: Aug. 16, 2011

(30) Foreign Application Priority Data
Jan. 27, 2009 (DE) 102009006283.1

(51) Int. Cl. F16D 65/092; F16D 55/22

(52) U.S. Cl. 188/73.1; 188/250 B

(57) ABSTRACT

The present invention relates to a brake pad arrangement having a pad carrier plate, on which a brake pad is disposed, wherein the brake pad on a friction surface has at least two contour edges, at which the brake pad is chamfered. According to the invention in order to suppress noise it is provided that the at least two contour edges extend substantially parallel to one another and at a predetermined angle relative to a radial centre line M of the brake pad.

### CROSS-REFERENCE TO RELATED APPLICATIONS

This application is a national stage of International Application No. PCT/EP2010/000110 filed Jan. 12, 2010, the disclosures of which are incorporated herein by reference in entirety, and which claimed priority to German Patent Application No. 10 2009 006 283.1 filed Jan. 27, 2009, the disclosures of which are incorporated herein by reference in entirety.

### BACKGROUND OF THE INVENTION

The present invention relates to a brake pad arrangement having a pad carrier plate, on which a brake pad is disposed, wherein the brake pad on a friction surface has at least two contour edges, at which the brake pad is chamfered.

Such brake pad arrangements are prior art and are disclosed for example in the patent document U.S. Pat. No. 7,275,625 B2. This document discloses brake pad arrangements having edges of various types of design, at which the brake pad is chamfered. The edges according to this document extend either parallel or obliquely relative to a radial centre line of the brake pad arrangement and in the direction of the two side edges, i.e. the friction surface of the brake pad between the edges is widened in the direction of the radially upper end of the brake pad arrangement.

The patent document DE 29 19 537 C2, and corresponding U.S. Pat. No. 4,220,223, both of which are incorporated by reference herein in entirety, also discloses a brake pad for disk brakes that is chamfered at two edges. The edges extend obliquely relative to a radial centre line of the brake pad arrangement and in the direction of the two side edges of the brake pad.

The European patent document EP 5 241 178 B1 discloses a brake block having a brake pad on a back plate that has been chamfered at two side edge zones and at an upper edge zone extending in peripheral direction. The chamfers in the side edge regions are hyperbolic in shape.

FR-OS 2 312 690 A1 describes a brake pad arrangement, in which a side edge region as well as the, in peripheral direction, lower region of the brake pad arrangement are chamfered.

FR-OS 2 482 687 A1 further discloses a brake pad on a pad carrier plate, which brake pad is chamfered at its, in peripheral direction, upper end.

The brake pad arrangements of prior art present contour edges of various types of design that have downward sloping chamfers, by means of which—as is generally known—in the fitted state in a disk brake the noise behaviour during a braking operation may be improved. It is however still possible for vibration-related noise emissions—undesirable “squealing”—to occur during a braking operation. The noise emissions are to be traced back to a resonance effect between the brake disk and the brake pads acting upon the brake disk that arises as a result of a compatibility of the brake pad with the vibrational properties of the brake disk during a braking operation. As a result of this compatibility the brake disk and the brake pads acting upon the brake disk form a vibrationally tuned system that may lead to the undesirable “squealing”.

The prior art brake pad arrangements and/or chamfers thereof moreover entail a relatively high manufacturing outlay as it takes a plurality of operations to complete them.

### BRIEF SUMMARY OF THE INVENTION

A feature of the present invention is therefore to provide a brake pad arrangement that prevents undesirable noise emissions and is at the same time easy and economical to manufacture.

This feature is achieved by a brake pad arrangement of the initially described type, in which the at least two contour edges extend substantially parallel to one another and at a predetermined angle relative to a radial centre line of the brake pad.

The fact that the contour edges extend parallel to one another and, not parallel, but obliquely at a predetermined angle to the radial centre line of the brake pad offers various acoustic and manufacture-related advantages over the brake pad arrangements of prior art. As the brake pad is of an asymmetrical design as a result of the contour edges being parallel but extending obliquely relative to the radial centre line, its mode of vibration during a braking operation does not correspond to the modes of vibration of the brake disk, with the result that the brake pad arrangements and the brake disk do not form a vibrationally tuned system. As a result, “squealing” may be effectively prevented.

Furthermore, the fact that the contour edges extend parallel to one another and obliquely at a predetermined angle relative to the centre line of the brake pad makes it markedly easier to manufacture such a brake pad arrangement as it may be manufactured in a single operation. In a production line the brake pad is conveyed in the desired oblique position between two cutters, which in one operation cut the mutually parallel chamfers into the brake pad.

According to a preferred embodiment of the invention the predetermined angle, at which the parallel contour edges extend relative to the centre line of the brake pad, lies in a range between 0° and 90°, preferably in a range between 5° and 25°. This angle may be selected differently in dependence upon the vehicle type and/or the dimensions of the brake, since each vehicle type and the associated, differently dimensioned brake disks exhibit different vibrational properties and/or natural frequencies. The brake pad arrangement may, by means of the angle to the radial centre line, be tuned to the respective modes of vibration of the brake disk in order to prevent an undesirable noise development. In other words, the brake pad arrangements may be tuned in such a way that no compatibility of the modes of natural vibration between the brake disk and the brake pads arises.

A preferred embodiment of the invention provides that the at least two parallel running contour edges extend asymmetrically relative to the centre line of the brake pad. In other words, this means that the at least two chamfers are disposed asymmetrically relative to the centre line of the brake pad and slope obliquely down from the at least two contour edges. By virtue of this asymmetry a vibrational compatibility of the brake disk with the brake pad arrangement during a braking operation is avoided, thereby preventing an undesirable noise emission.

According to a development of the invention the chamfers have an angle of inclination relative to the friction surface of the brake pad that lies in a range between 2 and 88°. In order to be able to vary the asymmetry of the brake pad arrangement in dependence upon the field of application, i.e. vehicle type and/or brake type, according to the invention the chamfers sloping obliquely down from the at least two contour edges have different angles of inclination relative to the friction surface of the brake pad. Thus, the chamfers may for example also have angles of inclination that differ in dependence upon the side of their arrangement relative to the disk brake.

The present invention further relates to a disk brake having at least two of the previously described brake pad arrangements, wherein the disk brake comprises at least one inner and one outer brake pad arrangement, which are disposed parallel to a brake disk that is rotatable about an axis of rotation, and wherein the brake pads lie opposite one another and face the brake disk.

A preferred embodiment of the invention provides that the two contour edges of the chamfers of the at least one inner and outer brake pad arrangement are designed in such a way that the contour edges of the chamfers of the mutually opposing brake pads, viewed in a projection directed along the axis of rotation, intersect.

As an alternative to the previously described embodiment, the two contour edges the chamfers of the at least one inner and outer brake pad arrangement may be designed in such a way that the contour edges the chamfers of the mutually opposing brake pads, viewed in a projection directed along the axis of rotation, extend substantially parallel to one another, in particular are coincident.

The present invention further relates also to a brake system for a motor vehicle that comprises at least two of the previously described disk brakes, which in turn comprise in each case two of the previously described brake pad arrangements. By means of the brake pad arrangements that are used, the brake systems may be tuned to various vehicle types and to the different natural frequencies and vibrational properties thereof. In other words, the brake pad arrangements may be designed and/or disposed in various ways within a brake system in order to be able to tune the brake system to a vehicle type.

There now follows a description of four preferred embodiments of a brake system according to the invention.

A preferred development of the invention provides that all of the brake pad arrangements of the at least two brake disks are of an identical design. This embodiment has the advantage that the number of different parts remains low, thereby offering the advantage of a low logistical outlay (stock keeping, sales and marketing, maintenance, etc.).

According to the invention it may alternatively be provided that the, in relation to the vehicle longitudinal axis, inner brake pad arrangements of the at least two disk brakes as well as the, in relation to the vehicle longitudinal axis, outer brake pad arrangements of the at least two disk brakes are in each case of an identical design, wherein the inner and outer brake pad arrangements associated with a specific brake disk differ from one another in the orientation of the contour edges.

A further alternative embodiment provides that the, in relation to the vehicle longitudinal axis, inner brake pad arrangements of the at least two disk brakes as well as the, in relation to the vehicle longitudinal axis, outer brake pad arrangements of the at least two disk brakes are in each case of a different design, wherein the inner and outer brake pad arrangements associated with a specific brake disk are identical in terms of the orientation of their contour edges.

According to a further preferred development the, in relation to the vehicle longitudinal axis, inner brake pad arrangements of the at least two disk brakes as well as the, in relation to the vehicle longitudinal axis, outer brake pad arrangements of the at least two disk brakes are in each case of a different design, wherein the inner and outer brake pad arrangements associated with a specific brake disk differ in the orientation of their contour edges.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a front view of a brake pad arrangement according to the invention;

FIG. 2 is a side view of the brake pad arrangement according to the invention;

FIGS. 3-6 are a first embodiment of a brake system according to the invention;

FIGS. 7-10 are a second embodiment of the brake system according to the invention;

FIGS. 11-14 are a third embodiment of the brake system according to the invention; and

FIGS. 15-18 are a fourth embodiment of the brake system according to the invention.

### DETAILED DESCRIPTION OF THE INVENTION

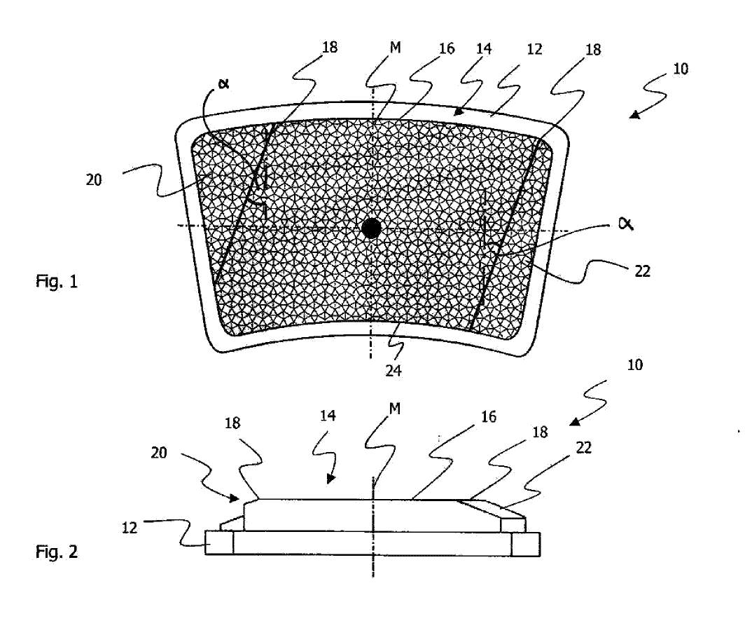

FIG. 1 shows a front view of the brake pad arrangement 10. The brake pad arrangement 10 comprises a brake pad carrier plate 12, on which a brake pad 14 is disposed. On a friction surface 16 of the brake pad 14 that is designed for brake-effective interaction with a brake disk two parallel running contour edges 18 are provided, which extend at a predetermined angle a to a radial centre line M of the brake pad arrangement 10.

As is further evident from FIG. 1, the two parallel contour edges 18 extend asymmetrically relative to the centre line M of the brake pad arrangement 10. The angle α, at which the contour edges 18 extend relative to the centre line M, lies preferably in a range between 1° and 90°, in particular between 5° and 25°, and in the illustrated example is 20°. As a result of the contour edges 18 extending asymmetrically relative to the centre line M, the chamfers 20 and 22 also slope down asymmetrically relative to the centre line M in the direction of a peripheral edge 24 of the brake pad 14.

FIG. 2 shows a side view of the brake pad arrangement 10. From FIG. 2 it may clearly be seen that the chamfers 20 and 22 sloping down from the contour edges 18 extend asymmetrically relative to the centre line M of the brake pad arrangement 10.

The fact that the contour edges 18 extend parallel to one another but at a predetermined angle α to the centre line M gives rise to an asymmetry that is advantageous in terms of noise development and/or for preventing noise emission. By means of the asymmetrical contour edges 18 and the chamfers 20 and 22 sloping asymmetrically down from these contour edges 18 the brake pad arrangements 10 in a state of installation in a disk brake may be made vibrationally incompatible with the brake disk (not shown here). In other words, the brake pad arrangements during a braking operation differ in their mode of vibration, in which they interact with the brake disk, from the mode of vibration of the brake disk, with the result that a vibrationally tuned system does not arise and noise emission—such as undesirable “squealing”—is effectively prevented.

From FIGS. 1 and 2 it is further evident that the brake pad arrangement 10 with its chamfers 20 and 22 is easy to manufacture. The brake pad arrangement 10 is conveyed, in a desired oblique position corresponding to the angle α, in a production line between two cutters. The chamfers 20, 22 of the brake pad arrangement 10 may therefore be produced in a single operation.

There now follows a description of various embodiments of the invention with reference to the further figures. To avoid repetition and simplify the description, for components of an identical effect or type the same reference characters as in the first embodiment are used, only prefixed by a consecutive number. To maintain the clarity of representation, in each case only one figure of an embodiment is provided completely with reference characters.

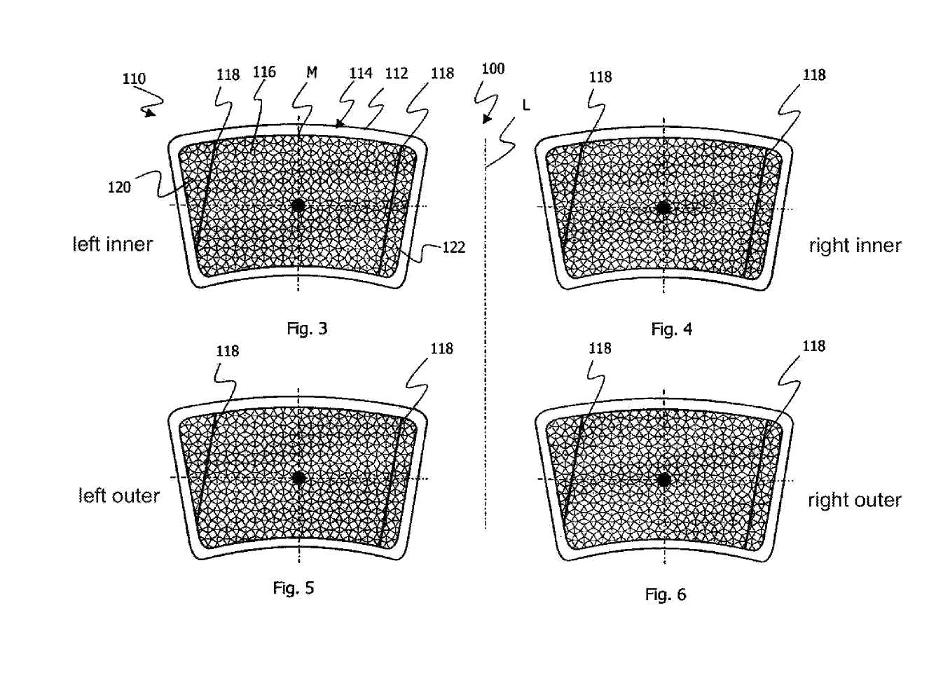

FIGS. 3 to 6 show a first embodiment of a brake system 100 having at least two brake disks (not shown here), each comprising two brake pad arrangements 110, which are disposed parallel to a brake disk that is rotatable about an axis of rotation and lie opposite one another facing the brake disk. For better pictorialization a vehicle longitudinal axis L is diagrammatically represented. FIGS. 3 and 5 show the brake pad arrangements 110 that come into operation on the left of the vehicle longitudinal axis L. In a corresponding manner, FIGS. 4 and 6 show brake pad arrangements 110 that are disposed in a disk brake on the right side of the vehicle.

As is evident from FIGS. 3 to 6, all of the brake pad arrangements 110 are of an identical design. This means that, when the brake pad arrangements 110 in the fitted state are situated pairwise on either side of a brake disk, the contour edges 118 of the chamfers 120, 122 of the inner brake pad arrangements 110 and the outer brake pad arrangements 110, viewed in a projection directed along the axis of rotation of a brake disk (not shown here), intersect.

In the embodiment according to FIGS. 3 to 6 the contour edges 118 of the left brake disk and the right brake disk therefore intersect. The orientation of the contour edges 118 of the brake pad arrangements 110 in relation to the vehicle longitudinal axis L is identical. The identical orientation of the contour edges 118 in identical brake pad arrangements 110 gives rise, in the state of installation in a disk brake (not shown), to an asymmetry relative to the vehicle longitudinal axis.

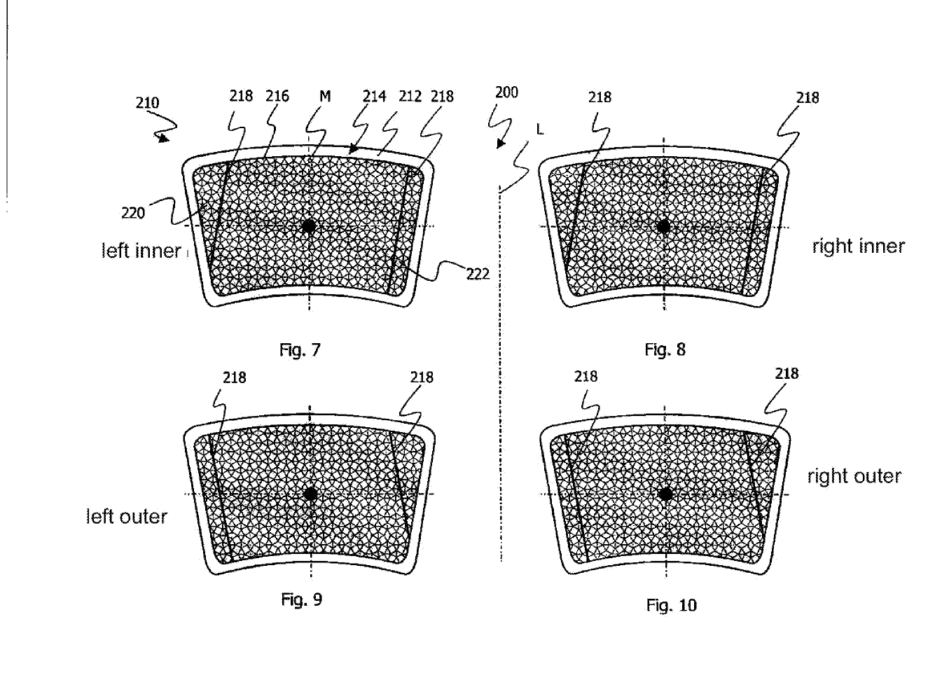

FIGS. 7 to 10 show a second embodiment of a brake system 200 according to the invention. As is evident from FIGS. 7 to 10, unlike the embodiment according to FIGS. 3 to 6 the brake pad arrangements 210 are not all of an identical design. Here, in each case the inner brake pad arrangements 210 according to FIGS. 7 and 8 and the outer brake pad arrangements 210 according to FIGS. 9 and 10 are identical to one another. Furthermore, the contour edges 218 of the inner and outer brake pad arrangements 210 have the same orientation in relation to the vehicle longitudinal axis L. Looking at the individual brake pad arrangements 210 on the left and right side of the vehicle longitudinal axis L it is apparent that in the fitted state of the brake pad arrangements 210, in a projection directed along the axis of rotation of a brake disk (not shown), the contour edges 218 of the inner and outer brake pad arrangements 210 extend substantially parallel and according to this embodiment in coincidence. The identical orientation of the contour edges 218 of the inner brake pad arrangements 210 according to FIGS. 7 and 8 and of the outer brake pad arrangements according to FIGS. 9 and 10 give rise in the fitted state to an asymmetry in the orientation of the contour edges 218 according to the vehicle longitudinal axis L.

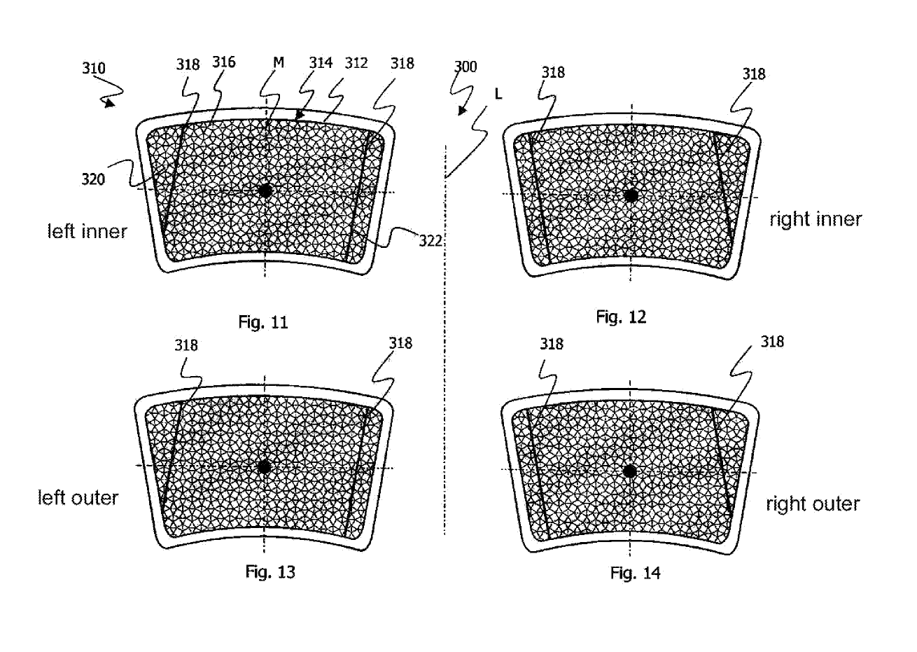

FIGS. 11 to 14 show a third embodiment of a brake system 300 according to the invention having at least two brake disks. It is evident from FIGS. 11 and 12 as well as FIGS. 13 and 14 that the inner brake pad arrangements 310 according to FIGS. 11 and 12 are designed differently in relation to the vehicle longitudinal axis L. What is more, the outer brake pad arrangements 310 according to FIGS. 13 and 14 differ from one another. From a comparison of the brake pad arrangements 310 on the right of the vehicle longitudinal axis L it is evident that these are of an identical design to one another, as are the brake pad arrangements 310 on the left of the vehicle longitudinal axis L. In a projection directed along the axis of rotation of a brake disk (not shown), the contour edges 318 of the inner and outer brake pad arrangements 310 intersect in the fitted state.

It is evident from FIGS. 11 to 14 that the contour edges 318 of the brake pad arrangements 310 on the left and on the right of the vehicle longitudinal axis L have the same orientation. The identical orientation of the contour edges 318 in relation to the vehicle longitudinal axis L gives rise, in the fitted state of the brake pad arrangements 310 in a disk brake (not shown), to a symmetry in relation to the vehicle longitudinal axis L between the left and the right side in the orientation of the contour edges 318 of the brake pad arrangements 310.

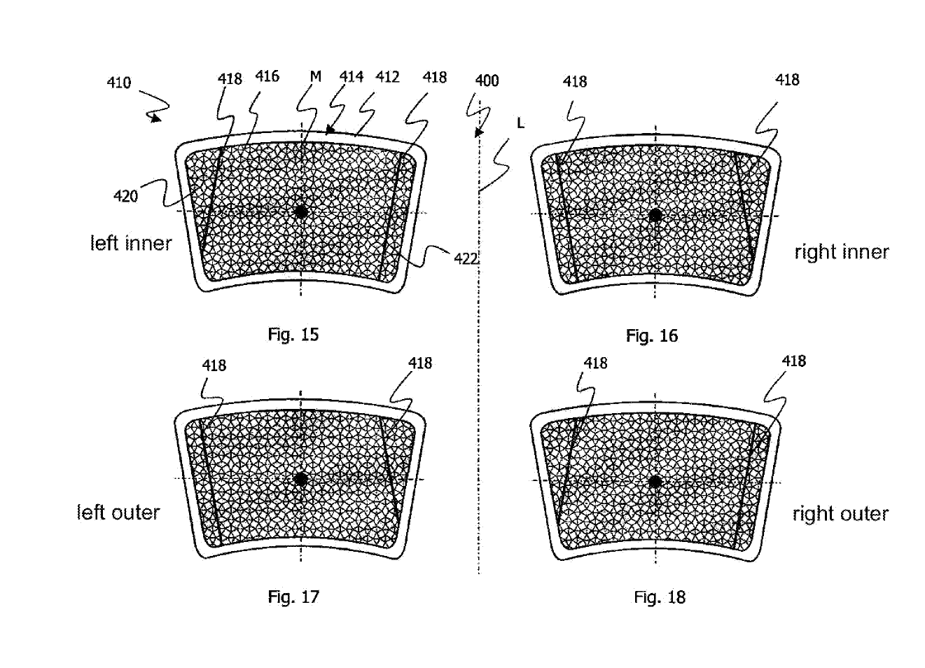

FIGS. 15 to 18 show a fourth embodiment of a brake system 400 according to the invention. In this brake system 400 both the inner and outer brake pad arrangements 410 are designed differently to one another. In the fitted state, given a pairwise arrangement on either side of a brake disk, the brake pad arrangements 410 disposed on the right or left side of the vehicle longitudinal axis L also differ from one another. In a projection along the axis of rotation of the brake disk, the contour edges 418 of the inner brake pad arrangements 410 according to FIGS. 14 and 15 and the contour edges 418 of the outer brake pad arrangements 410 extend parallel to one another. However, the contour edges 418 of the pad arrangements 410 differ in relation to the vehicle longitudinal axis L, thereby leading in the fitted state to a symmetry of the contour edges 418 in relation to the vehicle longitudinal axis L.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. Brake pad arrangement having a pad carrier plate, on which a brake pad is disposed, wherein the brake pad on a friction surface has at least two contour edges, at which the brake pad is chamfered,
wherein the at least two contour edges extend substantially parallel to one another and at a predetermined angle relative to a radial centre line of the brake pad.

2. Brake pad arrangement according to claim 1,
wherein the predetermined angle lies in a range between 0° and 90°.

3. Brake pad arrangement according to claim 1,
wherein the at least two contour edges extend asymmetrically relative to the radial centre line of the brake pad.

4. Brake pad arrangement according to claim 1,
wherein the chamfers slope obliquely down from the at least two contour edges asymmetrically relative to the radial centre line of the brake pad.

5. Brake pad arrangement according to claim 1,
wherein an angle of inclination of the chamfers relative to the friction surface of the brake pad lies in a range between 2° and 88°.

6. Brake pad arrangement according to claim 1,
wherein the chamfers sloping obliquely down from the at least two contour edges have different angles of inclination relative to the friction surface of the brake pad.

7. Disk brake having at least two brake pad arrangements according to claim 1, wherein the disk brake comprises at least one inner and one outer brake pad arrangement, which are disposed parallel to a brake disk that is rotatable about an axis of rotation, and wherein the brake pads lie opposite one another and face the brake disk.

8. Disk brake according to claim 7,
wherein the two contour edges of the chamfers of the at least one inner and outer brake pad arrangement are designed in such a way that the contour edges of the chamfers of the mutually opposing brake pads, viewed in a projection directed along the axis of rotation, intersect.

9. Disk brake according to claim 7,
wherein the two contour edges of the chamfers of the at least one inner and outer brake pad arrangement are designed in such a way, that the contour edges of the chamfers of the mutually opposing brake pads, viewed in a projection directed along the axis of rotation, extend substantially parallel to one another.

10. Brake system for a motor vehicle having at least two disk brakes according to claim 8 on both sides of a vehicle longitudinal axis,
wherein all of the brake pad arrangements of the at least two disk brakes are of an identical design.

11. Brake system having at least two disk brakes according to claim 9 on both sides of a vehicle longitudinal axis,
wherein an, in relation to the vehicle longitudinal axis, inner brake pad arrangement of the at least two disk brakes as well as the, in relation to the vehicle longitudinal axis, an outer brake pad arrangements of the at least two disk brakes are in each case identical to one another, wherein the inner and outer brake pad arrangements associated with a specific brake disk differ in the orientation of their contour edges from one another.

12. Brake system having at least two disk brakes according to claim 8 on both sides of a vehicle longitudinal axis,
wherein an, in relation to the vehicle longitudinal axis, inner brake pad arrangements of the at least two disk brakes as well as the, in relation to the vehicle longitudinal axis, an outer brake pad arrangement of the at least two disk brakes are in each case of a different design to one another, wherein the inner and outer brake pad arrangements associated with a specific brake disk correspond in terms of the orientation of their contour edges.

13. Brake system having at least two disk brakes according to claim 9 on both sides of a vehicle longitudinal axis,
wherein an, in relation to the vehicle longitudinal axis, inner brake pad arrangement of the at least two disk brakes as well as the, in relation to the vehicle longitudinal axis, an outer brake pad arrangement of the at least two disk brakes are in each case of a different design to one another, wherein the inner and outer brake pad arrangements associated with a specific brake disk differ from one another in terms of the orientation of their contour edges.

14. Brake pad arrangement according to claim 2,
wherein the predetermined angle lies in a range between 5° and 25°.

15. Disk brake according to claim 7,
wherein the two contour edges of the chamfers of the at least one inner and outer brake pad arrangement are designed in such a way, that the contour edges of the chamfers of the mutually opposing brake pads, viewed in a projection directed along the axis of rotation, are coincident.
